(19) United States
(12) Patent Application Publication
(10) Pub. No.: US 2013/0148540 A1
(43) Pub. Date: Jun. 13, 2013

(54) METHOD AND APPARATUS FOR CALL SET-UP BASED ON NETWORK AVAILABLE TO RECEIVER

(71) Applicant: SAMSUNG ELECTRONICS CO., LTD., Suwon-si (KR)

(72) Inventor: Tomomi TAKIZAWA, Yokohama-si (JP)

(73) Assignee: SAMSUNG ELECTRONICS CO., LTD., Suwon-si (KR)

(21) Appl. No.: 13/712,531

(22) Filed: Dec. 12, 2012

(30) Foreign Application Priority Data
Dec. 12, 2011 (JP) 2011-271516
Jun. 29, 2012 (KR) 10-2012-0071374
Nov. 21, 2012 (KR) 10-2012-0132606

(51) Int. Cl. H04L 12/24

(52) U.S. Cl. CPC H04L 41/0806
USPC 370/254

(57) ABSTRACT

A method for call set-up between a receiver and a transmitter via an Internet Protocol (IP) network, the method including setting a communication environment based on a network available to the receiver; and setting up a call based on the set communication environment. The communication environment is set by displaying available communication methods based on the network available to the receiver, and determining a communication method to be used from among the available display communication methods based on a user input.

### CROSS-REFERENCE TO RELATED PATENT APPLICATIONS

This application claims the benefit of Korean Patent Application No. 10-2012-0071374, filed on Jun. 29, 2012, Korean Patent Application No. 10-2012-0132606, filed on Nov. 21, 2012, and Japanese Patent Application No. 2011-271516, filed on Dec. 12, 2011, the disclosures of which are incorporated herein in their entirety by reference.

### BACKGROUND OF THE INVENTION

1. Field of the Invention

Methods and apparatuses consistent with exemplary embodiments relate to call set-up based on a network available to a receiver during a call via an Internet Protocol (IP) network.

2. Description of the Related Art

As smart phones have become more popular, the load on third generation (3G) networks has gradually increased. Also, users of devices having a communication function, e.g., personal computers (PCs), mobile phones, tablets, and televisions (TVs), are currently increasing. Besides, since these devices are configured to easily use, for example, contents on the Internet, the amount of communication traffic is increased and thus causes loads to a network. In particular, when a terminal device is used to perform a video call, the quality of the video call is easily affected by the speed of the network used by the terminal device. Thus, when a terminal device uses a 3G network with high load, the terminal device cannot appropriately use a video call function.

Also, a phone providing services by using an IP of a packet communication protocol (hereinafter referred to as an “IP phone”) is well known. Some terminal devices functioning as IP phones may be directly connected to each other based on a peer to peer (P2P) technology. Devices usable as IP phones are increased. For example, mobile phones, tablets, and TVs as well as PCs may be used as IP phones. However, if devices connected to a 3G mobile phone line (hereinafter referred to as a “3G line”) are used as IP phones to make a video call, since the amount of data is large, the video call is interrupted.

In addition, when a user assigns a plurality of identifications (IDs) to his/her respective terminal devices and uses the terminal devices, it is deemed that not all of the IDs can be employed for making a call. For example, if a user is at home and logs in by using an ID for a personal computer (PC) or a television (TV), further activates the PC or the TV to perform a call and goes out after that, the user cannot answer the phone in spite of a receiving signal. Thus, a call set-up with a terminal device portable by a user is needed.

### SUMMARY OF THE INVENTION

Exemplary embodiments provide a method and apparatus for call set-up based on a network available to a receiver during a call via an IP network.

According to an aspect of an exemplary embodiment, there is provided a method for call set-up between a receiver and a transmitter via an IP network, the method including setting a communication environment based on a network available to the receiver; and setting up a call based on the set communication environment.

The setting of the communication environment may include displaying available communication methods based on the network available to the receiver; and determining a communication method to be used from among the available display communication methods based on a user input, wherein the communication method may be a voice calling method or a video calling method.

The setting of the communication environment may include displaying available communication devices based on the network available to the receiver; and determining at least one communication device to which a call request is to be transmitted from among the available communication devices, based on a user input, wherein the setting up of a call may include transmitting a call request to the determined communication device.

The displaying of the available communication devices may include, when the receiver is capable of using a home network, displaying a communication device that is capable of using the home network.

The displaying of the available communication devices may include, when the receiver is capable of using a public wireless network, displaying a portable communication device that is capable of using the public wireless network.

### BRIEF DESCRIPTION OF THE DRAWINGS

The above and/or other aspects will become more apparent by describing in detail exemplary embodiments with reference to the attached drawings in which:

FIG. 1 is a block diagram of a system for call set-up based on a network available to a receiver, according to an exemplary embodiment;

FIG. 2 is a block diagram of a transmitter illustrated in FIG. 1 for call set-up based on the network available to the receiver illustrated in FIG. 1, according to an exemplary embodiment;

FIG. 3 is a block diagram of a transmitter that determines a communication method or a communication device based on a user input via the network available to the receiver illustrated in FIGS. 1 and 2 and sets up a call by using a determined communication method or communication device, according to an exemplary embodiment;

FIG. 4 is a flowchart of a method for call set-up based on a network available to the receiver illustrated in FIG. 1, according to an exemplary embodiment;

FIG. 5 is a flowchart of a method for call set-up based on a communication method or a communication device determined based on a network available to the receiver illustrated in FIG. 1 based on a user input, according to another exemplary embodiment;

FIG. 6 is a flowchart of a method for call set-up based on a communication method or a communication device determined based on a network available to the receiver illustrated in FIG. 1, according to another exemplary embodiment;

FIG. 7 is a block diagram of a call system for call set-up based on an available network, according to an exemplary embodiment;

FIG. 8 is a block diagram of a terminal device of a first system illustrated in FIG. 7, according to an exemplary embodiment;

FIG. 9 is a block diagram of a terminal device of a second system illustrated in FIG. 7, according to an exemplary embodiment;

FIG. 10 is a table showing information registered to a registration device illustrated in FIG. 7, according to an exemplary embodiment;

FIG. 11 is a table showing data of an address book memory, which is obtained and managed by the terminal device of the second system illustrated in FIG. 7, according to an exemplary embodiment;

FIG. 12 is a flowchart of a method for call set-up based on an available network, according to an exemplary embodiment;

FIG. 13 is an image of a call function selection screen displayed on a display unit of the terminal device of the second system illustrated in FIG. 7, according to an exemplary embodiment;

FIG. 14 is a block diagram of a call system for call set-up based on an available network, according to another exemplary embodiment;

FIG. 15 is a table showing information registered to a registration device illustrated in FIG. 14, according to an exemplary embodiment;

FIG. 16 is a block diagram of a call system for call set-up based on an available network, according to another exemplary embodiment;

FIG. 17 is a block diagram of a terminal device of a first system illustrated in FIG. 16, according to an exemplary embodiment; and

FIG. 18 is a flowchart of a method for call set-up based on an available network, according to another exemplary embodiment.

### DETAILED DESCRIPTION OF EXEMPLARY EMBODIMENTS

The present invention will now be described more fully with reference to the accompanying drawings, in which exemplary embodiments of the invention are shown. In the following description and the accompanying drawings, well-known functions or constructions are not described in detail since they would obscure the invention with unnecessary detail. In addition, like reference numbers are used to refer to like elements through at the drawings.

The terminology or words used in the specification and claims described below must not be analyzed as having the common or lexical meaning and must be analyzed as having the meaning and describing the concept according to the technical spirit of the present invention so that the inventor can properly define the invention. Therefore, since the embodiments disclosed below and the configurations shown in the drawings are only the most exemplary embodiments of the present invention and do not represent all technical spirit of the present invention, it should be understood that various equivalents and modifications for replacing the embodiments may exist.

The terminology ‘call set-up’ refers to a process for setting a communication line between two terminals, which includes selecting an address identification (ID) required by a transmitter in a network and a path via a network, and allowing a receiver to be connected to the transmitter. That is, the call set-up refers to a process whereby a transmitter transmits a signal via a network and is connected to a receiver.

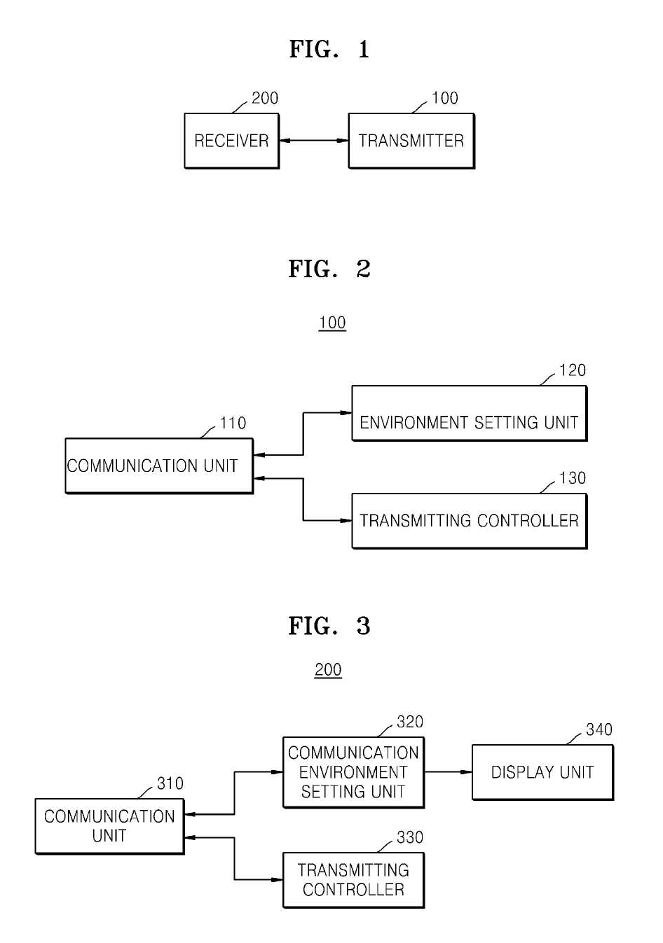

FIG. 1 is a block diagram of a system for call set-up based on a network available to a receiver 200 according to an exemplary embodiment.

Referring to FIG. 1, the system for call set-up based on a network available to a receiver 200 may include a transmitter 100 and the receiver 200.

The transmitter 100 and the receiver 200 may communicate with each other via various types of networks used by a user and may each be, for example, a personal computer (PC), a notebook computer, a mobile phone, a tablet PC, a navigation device, a smart phone, a personal digital assistant (PDA), a smart television (TV), a portable multimedia player (PMP), or a digital broadcast receiver.

The transmitter 100 and the receiver 200 may use, but the present invention is not limited thereto, a communication method using an Internet Protocol (IP) or a communication method such as a peer to peer (P2P) method or a push-type method.

FIG. 2 is a block diagram of the transmitter 100 illustrated in FIG. 1 for call set-up based on a network available to the receiver 200 illustrated in FIG. 1, according to an exemplary embodiment.

Referring to FIG. 2, the transmitter 100 may include a communication unit 110, a communication environment setting unit 120, and a transmitting controller 130.

The communication unit 110 may communicate with another device via a network.

The communication environment setting unit 120 may set a communication environment based on a network available to the receiver 200. Whenever a network environment of the receiver 200 is changed, the receiver 200 may transmit information about the available network to an external server via the available network at that time and may store the information in the external server. Thus, in the case of call set-up for communication with the receiver 200 via an IP network, the transmitter 100 may receive the information about the network available to the receiver 200 from the external server, may set a communication environment, and may set up a call.

The transmitting controller 130 may set up a call via an IP network based on the set communication environment.

FIG. 3 is a block diagram of a transmitter 300 that determines a communication method or a communication device based on a user input via a network available to the receiver 200 illustrated in FIGS. 1 and 2 and sets up a call by using the determined communication method or communication device, according to an exemplary embodiment.

Referring to FIG. 3, the transmitter 300 may include a communication unit 310, a communication environment setting unit 320, a transmitting controller 330, and a display unit 340. The communication unit 310, the communication environment setting unit 320, and the transmitting controller 330 illustrated in FIG. 3 may correspond to the communication unit 110, the communication environment setting unit 120, and the transmitting controller 130 illustrated in FIG. 2, respectively, and thus, a repeated explanation of these components will not be given.

The communication environment setting unit 320 may set a communication environment based on the network available to the receiver 200. In this case, the communication environment setting unit 320 may determine optimal communication methods or communication devices based on the network available to the receiver 200, may display a list of the communication methods or the communication devices based on an priority order of the communication methods or the communication devices, or may determine a communication method or a communication device based on a user input.

According to the present exemplary embodiment, when the communication environment setting unit 320 determines the communication methods or the communication devices to which a call request is to be transmitted, the communication environment setting unit 320 determines a priority order of the communication methods or the communication devices based on the network available to the receiver 200, may display a list of the communication methods or the communication devices, and may determine a communication method that is to be performed in the transmitter 300 or a communication device to which a call request is to be transmitted during a voice call or a video call, based on a user input. According to an exemplary embodiment, the set communication method is not limited to a voice call or a video call, and may include other communication methods.

When the communication environment setting unit 320 sets a communication method, if the network available to the receiver 200 is a 3G network or a network in which a video call is not appropriately performed, the communication environment setting unit 320 may preferentially display a voice call, and may determine based on a user input a communication method that is to be performed by the transmitter 100 from among the voice call and the video call. When the network available to the receiver 200 is a wireless local area network (LAN), a long term evolution (LTE), femtocell, or a network in which a video call is appropriately performed, the communication environment setting unit 320 may preferentially display a video call, and may determine based on a user input a communication method that is to be performed by the transmitter 100 from among the voice call and the video call.

Thus, the transmitter 300 may determine whether a video call or a voice call is performed based on the network available to the receiver 200.

In addition, when the communication environment setting unit 320 determines a communication device to which a call request is to be transmitted, the communication environment setting unit 320 may approximately determine a position of the user of the receiver 200 by using the network available to the receiver 200 and may determine the communication device to which a call request is to be transmitted. In this case, the receiver 200 is a portable device that allows recognition of the position of a user and may be, for example, a notebook computer, a tablet PC, or a smart phone.

When the receiver 200 is positioned in a region where a home wireless LAN is available, it may be determined that the user of the receiver 200 is at home. Thus, based on a user input of the transmitter 300, the communication environment setting unit 320 may use the home wireless LAN, may display a list of at least one communication device that is selected based on whether the same identification (ID) as that of the receiver 200 is used or predetermined identifying information, and may determine a communication device to which a call request is to be transmitted. In this case, the ID may be a user ID used in an application capable of communicating by using an IP. In addition, the predetermined identifying information may include information about a communication device that is used by a user that is the same as or related to the user of the receiver 200. The home wireless LAN may be a wireless LAN used at the user's or a place where the user resides and is not open to the public. In addition, the communication method is not limited to a LAN, and may be other wireless communication methods.

When the receiver 200 is a positioned in a place where a public wireless LAN is available, it may be determined that the user of the receiver 200 has gone out. Thus, based on a user input of the transmitter 300, the communication environment setting unit 320 may display a list of at least one portable communication device that uses the same ID as that of the receiver 200 or is selected based on predetermined identifying information and may determine a communication device to which a call request is to be transmitted and that performs communication. The public wireless LAN is a wireless LAN used in a region that is open to the public and is not a residential area. In addition, the communication method is not limited to a LAN, and may be other wireless communication methods.

According to the present exemplary embodiment, when the communication environment setting unit 320 determines a communication method or a communication device, an optimal communication method or communication device may be determined based on the network available to the receiver 200 without receiving an input from the user of the transmitter 300.

The communication environment setting unit 320 determines whether a video call is easily performed based on the network available to for the receiver 200 and may determine a communication method from among a voice call or a video call to be performed by the transmitter 100.

When the communication environment setting unit 320 determines a communication device to which a call request to be transmitted, if the receiver 200 is positioned in a place where a wireless LAN is available, the communication environment setting unit 320 may use the home wireless LAN and may transmit a call request to at least one communication device that is determined based on whether the same ID as that of the receiver 200 is used or predetermined identifying information.

When the receiver 200 is positioned in a region where a public wireless LAN is available, the communication environment setting unit 320 may transmit a call request to at least one portable communication device that uses the same ID as that of the receiver 200 or is selected based on predetermined identifying information.

According to an exemplary embodiment, the communication environment setting unit 320 may further consider networks available to the transmitter 300. When a network available to the transmitter 300 and the receiver 200 is a network in which a video call is appropriately performed, the communication environment setting unit 320 may preferentially display a video call and may determine a communication method to be performed by the transmitter 100 based on a user input or may set the transmitter 300 to perform a video call.

According to an exemplary embodiment, when a user of the transmitter 300 tries to speak to a user of the receiver 200 on the phone, the transmitter 300 may determine communication devices to which a call request is to be transmitted and may simultaneously transmit a call request to at least one communication devices. When the user of the receiver 200 accepts a call request from any communication device from among the communication devices that receive the call request, the user of the transmitter 300 may speak to the user of the receiver 200.

Thus, when the receiver 200 is not a portable device, such as a TV or a PC, an approximate position of the user of the receiver 200 may be determined based on a portable device such as a smart phone and whether a call request is also transmitted to the portable device of the user may be determined too. Thus, when the user of the receiver 200 goes out, even if a call request is transmitted to a communication device that is not portable, the portable device receives the call request and may perform a call with the user of the transmitter 300.

The transmitting controller 330 may control the transmitter 300 to set up a call with the receiver 200 by transmitting a call request to at least communication device and setting a communication that transmits a response signal as the receiver 200.

The display unit 340 may display a list of communication methods or communication devices that are generated based on an order of priority.

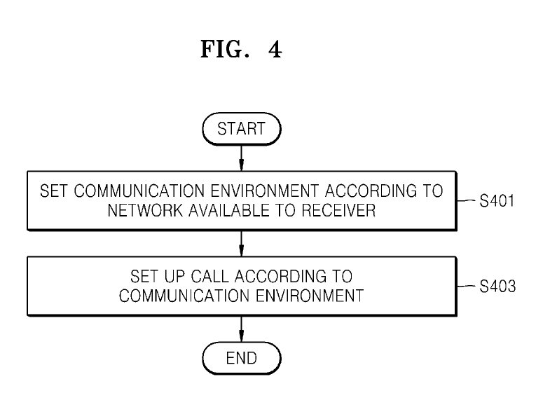

FIG. 4 is a flowchart of a method for call set-up based on a network available to the receiver 200 illustrated in FIG. 1, according to an exemplary embodiment.

Referring to FIG. 4, the communication environment setting unit 120 of the transmitter 100 may set a communication environment based on a network available to the receiver 200 (S401) and may set up a call with the receiver 200 via the transmitting controller 130 based on the set communication environment (S403). According to an exemplary embodiment, the transmitter 100 may set an optimal communication environment based on the network available to the receiver 200.

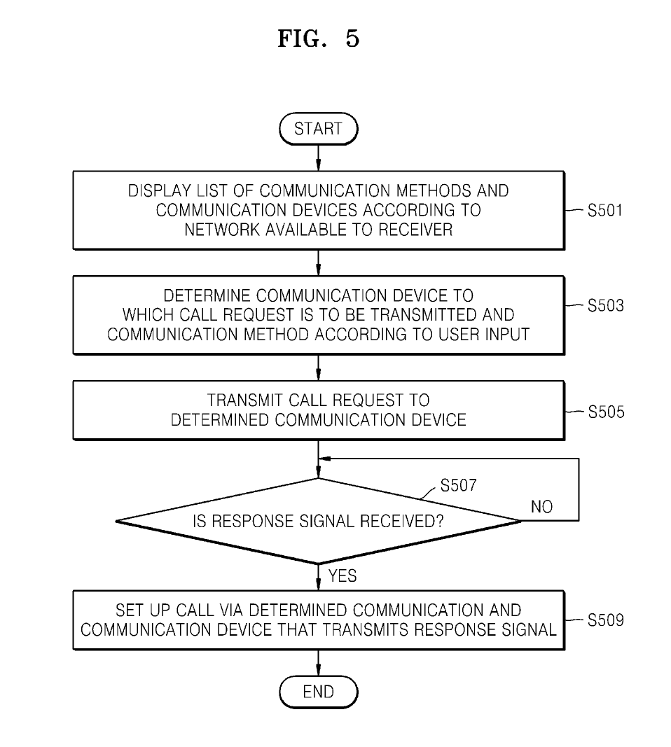

FIG. 5 is a flowchart of a method for call set-up based on a communication method or a communication device determined based on a network available to the receiver 200 illustrated in FIG. 1 based on a user input, according to another exemplary embodiment.

The transmitter 300 may display a list of available communication methods and communication devices determined based on a network available to the receiver 200, based on an order of priority of the communication methods and communication devices (S501). In addition, the transmitter 300 may determine based on a user input a communication method and a communication device to which a call request is to be transmitted (S503). The transmitter 300 may transmit a call request to at least one communication device (S505). When the transmitter 300 receives a response signal from the at least one communication device (S507—YES), the transmitter 300 may set the communication device that transmits the response signal that is received first as the receiver 200, may set up a call via the determined communication method, and may perform a call with the receiver 200 (S509).

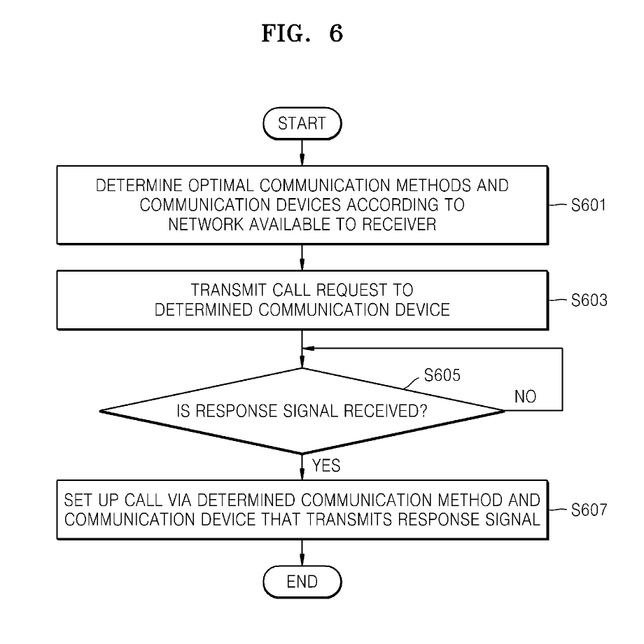

FIG. 6 is a flowchart of a method for call set-up based on a communication method or a communication device determined based on a network available to the receiver 200 illustrated in FIG. 1, according to another exemplary embodiment.

The transmitter 300 may determine optimal communication methods and communication devices based on a network available to the receiver 200 (S601). The transmitter 300 transmits a call request to at least one communication device (S603). When the transmitter 300 receives a response signal from the at least one communication device (S605—YES), the transmitter 300 sets the communication device that transmits the response signal that is received first as the receiver 200, may set up a call via the determined communication method, and may perform a call with the receiver 200 (S607).

A method for call set-up based on an available network by using a registration device for storing information about terminal devices for performing communications, according to embodiments of the present invention, will now be described.

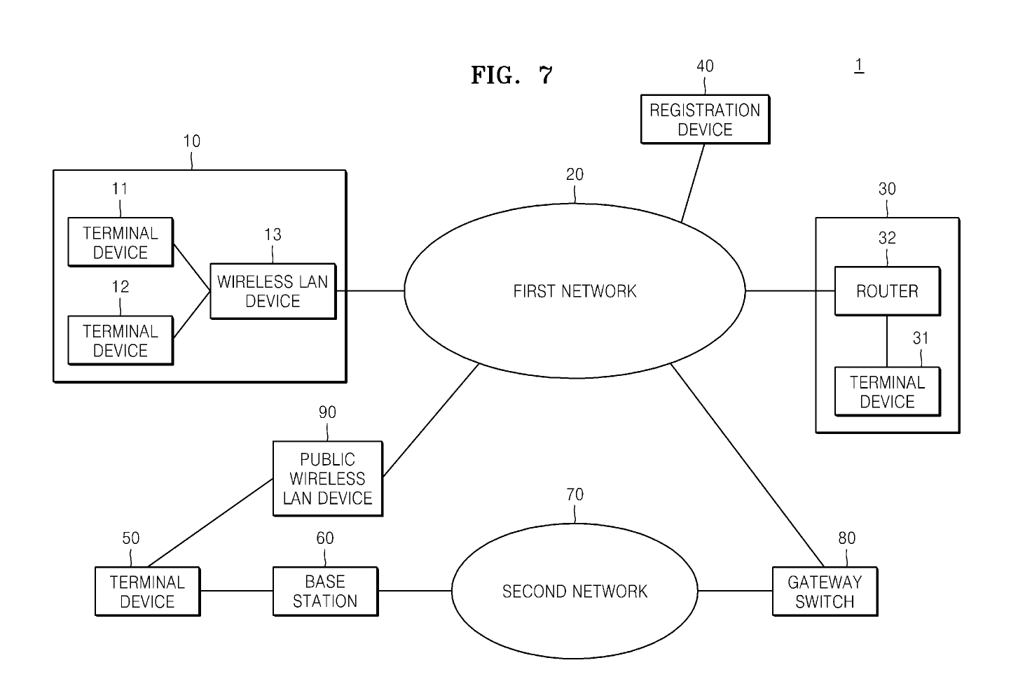

FIG. 7 is a block diagram of a call system 1 for call set-up based on an available network, according to an exemplary embodiment.

Referring to FIG. 7, the call system 1 may include a first system 10, a first network 20, a second system 30, a registration device 40, a terminal device 50, a base station 60, a second network 70, a gateway switch 80, and a public wireless LAN device 90.

A terminal device 31 of a caller (a source) may obtain from the registration device 40 line information about lines to which terminal devices 11, 12, and 50 of a callee (a destination) are connected.

The terminal device 31 may select a communication mode based on the obtained line information. The terminal device 31 may make a call to the terminal device 11, 12, or 50 by using the selected communication mode (or a call mode). In this case, the selecting of the communication mode may mean that the terminal device 31 selects a network to be used for communications, a callee's terminal device to communicate with, and whether to make a video call or a voice call.

The first system 10 may be, for example, an intranet installed in a house, and may include the terminal device 11, the terminal device 12, and a wireless LAN device 13.

Each of the terminal devices 11 and 12 may has a function of a phone providing services by using an IP of a packet communication protocol (hereinafter referred to as an IP phone). The terminal device 11 may be, for example, a PC and is connected to the wireless LAN device 13 by performing communications based on the wireless LAN standards. The terminal device 12 may be, for example, a TV and is connected to the wireless LAN device 13 by performing communications based on the wireless LAN standards.

The wireless LAN device 13 may have a function of a router for performing communications based on the wireless LAN standards. The terminal devices 11 and 12 are connected to the wireless LAN device 13. If the terminal device 50 is in a predetermined range of the first system 10, the terminal device 50 may also be connected to the wireless LAN device 13. The wireless LAN device 13 may connect the terminal devices 11 and 12 and the first network 20.

The first network 20 may be, for example, the Internet.

The second system 30 may be, for example, an intranet installed in a house, and may include the terminal device 31 and a router 32.

The terminal device 31 may be, for example, a PC, and is connected to the router 32 via a LAN cable.

The router 32 connects the terminal device 31 and the first network 20.

The registration device 40 may be, for example, a server, and may include ID information (for IP phones), device type information, and service area information of the terminal devices 11, 12, 50, and 31. The device type information is information about device types of the terminal devices 11, 12, 50, and 31 and indicates, for example, a TV, a PC, a smartphone, a tablet terminal device, etc. The service area information is information indicating the type of a network, i.e., a communication method, used by each of the terminal devices 11, 12, 50, and 31. The service area information may include, for example, information about connection by a home wireless LAN (a first communication method) (hereinafter referred to as home wireless LAN connection), connection by a public wireless LAN (a second communication method) (hereinafter referred to as public wireless LAN connection), and connection by a 3G line (a third communication method) (hereinafter referred to as 3G line connection). The ID information refer to ID numbers issued by companies who provide IP phone services to users of the first and second systems 10 and 30.

The terminal device 50 may be, for example, a smartphone. If the terminal device 50 is in a predetermined range of the first system 10, the terminal device 50 is connected to the wireless LAN device 13. Otherwise, if the terminal device 50 is in a predetermined range of a public wireless LAN, the terminal device 50 is connected to the public wireless LAN device 90. Alternatively, the terminal device 50 is connected to the base station 60 of a 3G line.

The base station 60 is a device for performing wireless communications with a wireless terminal device via a 3G line. The base station 60 is connected to the second network 70.

The second network 70 is a network of a 3G line.

The gateway switch 80 converts data used in the second network 70 into data used in the first network 20, and transmits the converted data to the first network 20. Alternatively, the gateway switch 80 converts data used in the first network 20 into data used in the second network 70, and transmits the converted data to the second network 70.

The public wireless LAN device 90 is a device for enabling an internet connection service via a wireless LAN installed at, for example, public facilities, stations, and restaurants (stores).

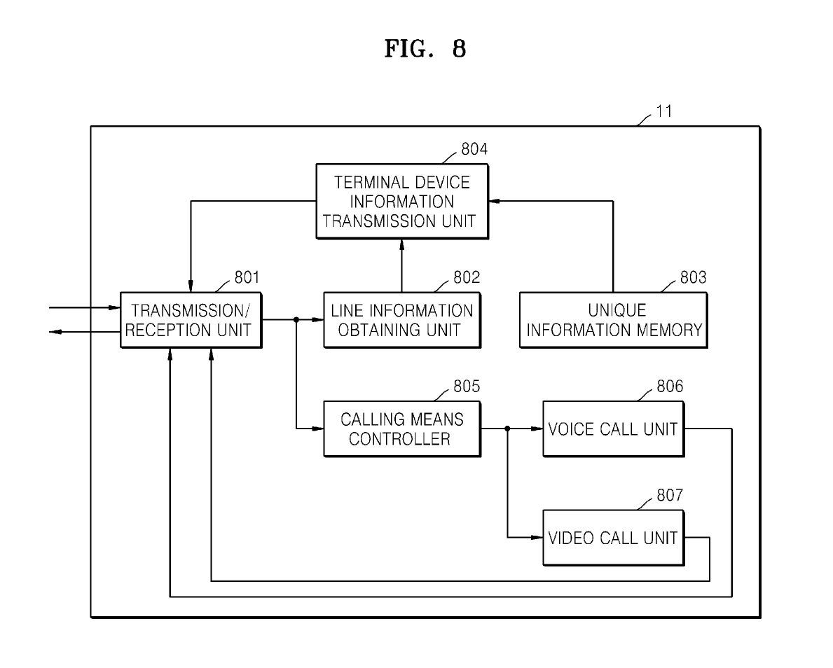

FIG. 8 is a block diagram of the terminal device 11 illustrated in FIG. 7, according to an exemplary embodiment.

Referring to FIG. 8, the terminal device 11 may include a transmission/reception unit 801, a line information obtaining unit 802, a unique information memory 803, a terminal device information transmission unit 804, a call unit controller 805, a voice call unit 806, and a video call unit 807.

In addition, the terminal devices 12 and 50 may also include the elements of the terminal device 11 illustrated in FIG. 8.

The transmission/reception unit 801 transmits a transmission signal and receives a reception signal via the wireless LAN device 13.

The line information obtaining unit 802 obtains from the transmission/reception unit 801 information indicating the type of a line to which the terminal device 11 is connected, and may generate service area information based on the obtained information. The line information obtaining unit 802 may transmit the generated service area information to the terminal device information transmission unit 804.

The unique information memory 803 may store unique information of a user as ID information of the terminal device 11, and device type information.

In addition, the unique information memory 803 of the terminal device 12 may store ID information and device type information of the terminal device 12. The unique information memory 803 of the terminal device 50 may store ID information and device type information of the terminal device 50.

The terminal device information transmission unit 804 may obtain the ID information and the device type information of the terminal device 11 from the unique information memory 803. The terminal device information transmission unit 804 relates the obtained ID information and the device type information of the terminal device 11 with the service area information received from the line information obtaining unit 802, and may transmit them via the transmission/reception unit 801 to the registration device 40.

The call unit controller 805 extracts a call mode from the transmission signal transmitted by the transmission/reception unit 801 from the terminal device 31 of a caller. The call unit controller 805 may select the voice call unit 806 or the video call unit 807 based on the extracted call mode, and may control the selected call unit to make a call.

The voice call unit 806 may be controlled by the call unit controller 805 to make a voice call.

The video call unit 807 may be controlled by the call unit controller 805 to make a video call.

In addition, if the terminal devices 11, 12, and 50 are directly connectable to the second network 70, the transmission/reception unit 801 illustrated in FIG. 8 may transmit the transmission signal and may receive the reception signal via an antenna (not shown).

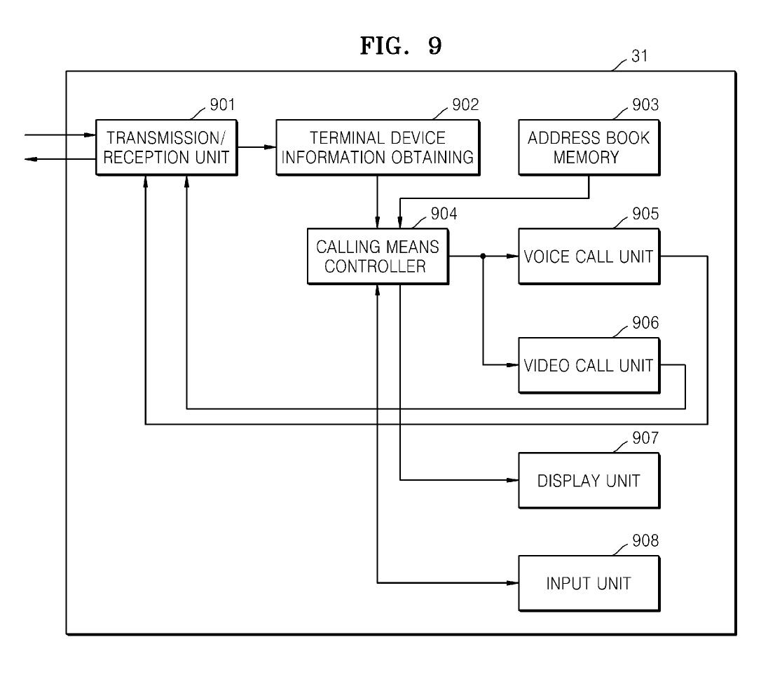

FIG. 9 is a block diagram of the terminal device 31 illustrated in FIG. 7, according to an exemplary embodiment.

Referring to FIG. 9, the terminal device 31 may include a transmission/reception unit 901, a terminal device information obtaining unit 902, an address book memory 903, a call unit controller 904, a voice call unit 905, a video call unit 906, a display unit 907, and an input unit 908.

The transmission/reception unit 901 transmits a transmission signal and receives a reception signal via the router 32.

The terminal device information obtaining unit 902 may obtain from the registration device 40 service area information of each terminal device, which is registered in relation to ID information of a callee. The terminal device information obtaining unit 902 may transmit the obtained service area information to the call unit controller 904.

The address book memory 903 stores callee information, ID information, and device type information in relation to each other.

The call unit controller 904 relates the service area information output from the terminal device information obtaining unit 902 with the callee information, the ID information, and the device type information read from the address book memory 903, and may control the display unit 907 to display the related information. The call unit controller 904 may select the voice call unit 905 or the video call unit 906 based on a communication function selected by a user via the input unit 908, and may control to make a call by using the selected call unit.

The voice call unit 905 is controlled by the call unit controller 904 to make a voice call.

The video call unit 906 is controlled by the call unit controller 904 to make a video call.

The display unit 907 may be, for example, a monitor. The input unit 908 may be, for example, a keyboard or a mouse. In addition, if the display unit 907 has a function of a touch panel, the display unit 907 may also function as the input unit 908.

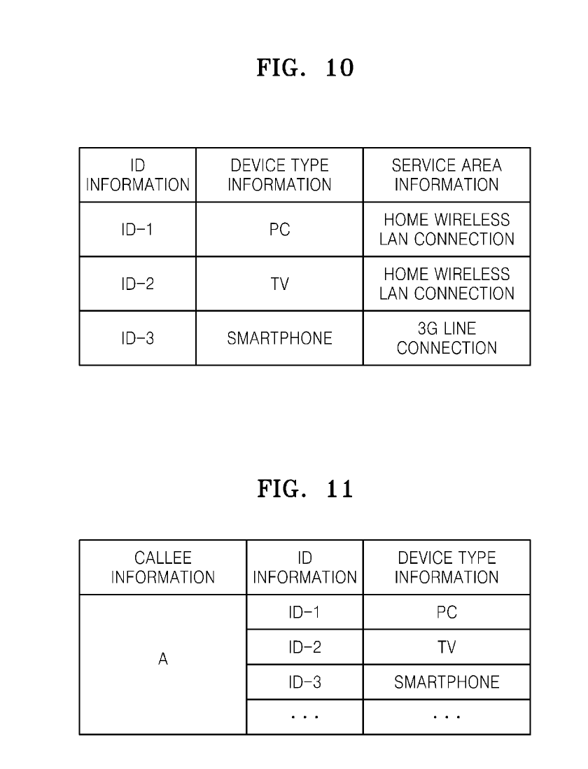

FIG. 10 is a table showing information registered to the registration device 40 illustrated in FIG. 7, according to an exemplary embodiment.

Referring to FIG. 10, the registration device 40 may store information about each terminal device as ID information, device type information, and service area information in the form of a table.

For example, referring to the second line of the table shown in FIG. 10, the information about the terminal device 11 includes the ID information as ID-1, the device type information as a PC, and the service area information as home wireless LAN connection.

FIG. 11 is a table showing data of the address book memory 903, which is obtained and managed by the terminal device 31 illustrated in FIG. 7, according to an exemplary embodiment.

Referring to FIG. 11, the address book memory 903 may store callee information (for example, a name), ID information of the callee, and device type information about devices used by the ID information, in relation to each other. The ID information and the device type information may, for example, be previously transmitted from the callee to a caller by using an e-mail, etc.

The address book memory 903 may store the related information of a plurality of callees.

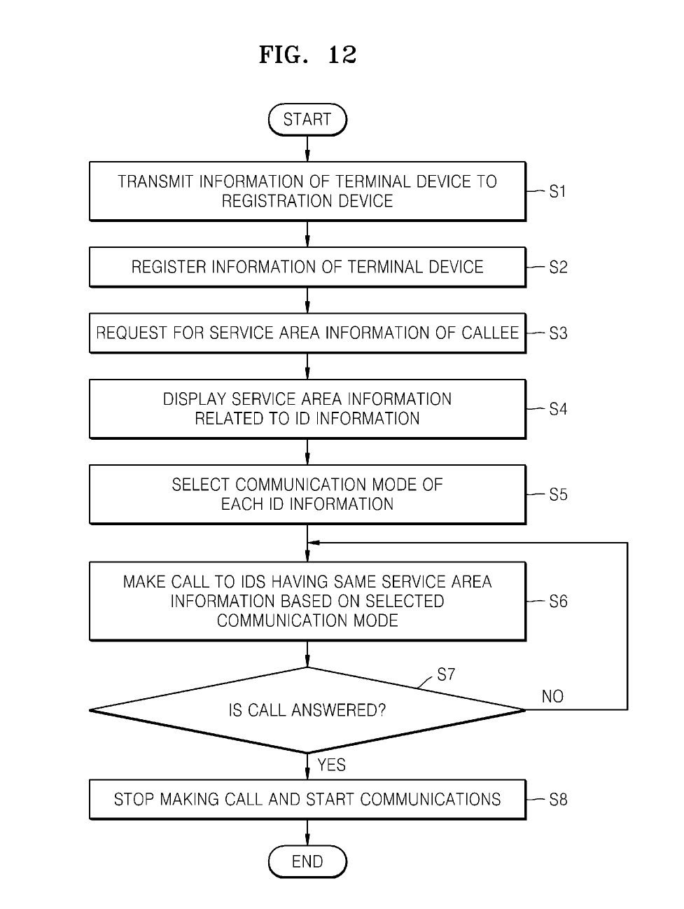

FIG. 12 is a flowchart of a method for call set-up based on an available network, according to an exemplary embodiment;

In operation S1, a callee registers ID information, device type information, and service area information of the terminal devices 11, 12, and 50 used by the callee, via the first and second networks 20 and 70 to the registration device 40. For example, the terminal device information transmission unit 804 of the terminal device 11 relates and transmits to the registration device 40 the service area information obtained by the line information obtaining unit 802 and the ID information and the device type information read from the unique information memory 803.

In FIGS. 7 and 10, the terminal device 11 has the device type information as a PC, the ID information as ID-1, and the service area information as home wireless LAN connection. The terminal device 12 has the device type information as a TV, the ID information as ID-2, and the service area information as home wireless LAN connection. The terminal device 50 has the device type information as a smartphone, the ID information as ID-3, and the service area information as 3G line connection.

In operation S2, the registration device 40 relates and registers the ID information, the device type information, and the service area information transmitted from the terminal devices 11, 12, and 50, to a memory.

In addition, information indicating a home wireless LAN line or a public wireless LAN line may be manually registered by the callee from each terminal device to the registration device 40. Alternatively, a name of a server used to received information from each terminal device may be checked and registered by the registration device 40.

In operation S3, a caller selects a callee from the address book memory 903 of the terminal device 31. The terminal device information obtaining unit 902 of the terminal device 31 extracts from the address book memory 903 ID information memorized in relation to the selected callee. Then, the terminal device information obtaining unit 902 transmits to the registration device 40 the extracted ID information and a request for service area information related to the ID information.

Then, based on the ID information and the request received from the terminal device 31, the registration device 40 extracts and transmits to the terminal device 31 service area information related to the ID information.

In more detail, the caller selects a callee A in the table shown in FIG. 11. The terminal device information obtaining unit 902 extracts ID information ID-1 to ID-3 memorized in relation to the callee A. The terminal device information obtaining unit 902 transmits to the registration device 40 the extracted ID information ID-1 to ID-3 and a request for service area information. Based on the ID information ID-1 to ID-3 and the request received from the terminal device 31, the registration device 40 extracts service area information memorized in relation to, for example, ID-1 as ‘home wireless LAN connection’ in the table shown in FIG. 10. The registration device 40 transmits to the terminal device 31 the extracted service area information, i.e., ‘home wireless LAN connection’, in relation to ID-1.

In operation S4, the terminal device information obtaining unit 902 generates display information by relating the service area information obtained from the registration device 40, to the callee information and the ID information memorized in the address book memory 903. The terminal device information obtaining unit 902 displays the generated display information on the display unit 907 of the terminal device 31.

In operation S5, the caller views the service area information displayed on the display unit 907 and related to each ID of the callee, and selects a call function of each ID by using the input unit 908. The call function is a voice call or a video call.

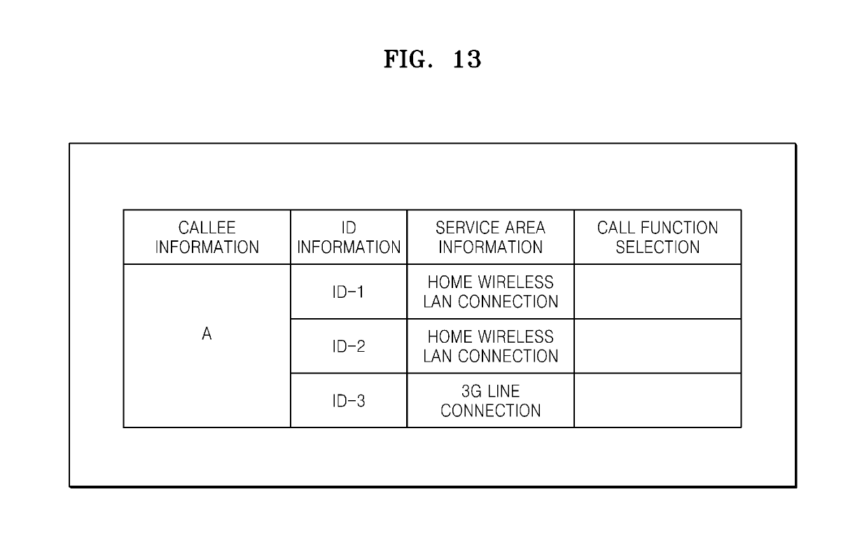

FIG. 13 is an image of a call function selection screen displayed on the display unit 907 of the terminal device 31 illustrated in FIG. 7, according to an exemplary embodiment.

Referring to FIG. 13, the call function selection screen may display the callee information, the ID information of the callee, the service area information obtained from the registration device 40, and a call function selection column in the form of, for example, a table.

In FIG. 13, the caller determines that ID-1 is used inside the first system 10, i.e., home, is connected to a wireless LAN environment, and thus is capable of transmit and receive a video. Accordingly, the caller may select a call function of ID-1 as a video call. Then, the caller determines that, like ID-1, ID-2 is also used home, and may select a call function of ID-2 as a video call. Then, the caller determines that ID-3 is connected to a 3G line and thus transmission and reception of a video is possibly interrupted. Accordingly, the caller determines a call function of ID-3 as a voice call. That is, the caller may select a call function in correspondence with the service area information indicating a network to which each terminal device of the callee is connected.

Alternatively, if the callee stays inside the first system 10 and thus the terminal device 50 is inside the first system 10, the terminal device 50 may automatically detects and be connected to the wireless LAN device 13. As described above, if the service area information of the terminal device 50 indicates home wireless LAN connection, the caller determines that the callee is home and may select a call function of the terminal device 50 as a video call.

In operation S6, the call unit controller 904 of the terminal device 31 may make a call to one or more IDs having the same service area information, based on the selected call function. For example, the terminal devices 11, 12, and 50 (ID-1, ID-2, and ID-3) have the same service area information, e.g., home wireless LAN connection, the call unit controller 904 may make a call to ID-1, ID-2 and ID-3 in a call mode for making a video call by using the video call unit 906. In addition, a transmission signal of the call unit controller 904, which is transmitted by using the voice call unit 905 or the video call unit 906, may include information indicating the call mode.

In operation S7, the call unit controller 904 determines whether the call is answered. If the call is not answered (S7—NO), the method proceeds to operation S6 and a call is repeatedly made a present number of times or during a preset period of time.

If the call is answered (S7—YES), the call unit controller 904 stops making a call to a terminal device that answers the call in operation S8. Then, the call unit controller 904 performs communications with the terminal device that answers the call, based on the set call function.

The call unit controller 805 of the callee's terminal device (the terminal device 11, 12, or 50) extracts information indicating the call mode, from the transmission signal transmitted from the terminal device 31. The call unit controller 805 may perform communications with the terminal device 31 of the caller based on the extracted call mode by using the voice call unit 806 or the video call unit 807.

As described above, according to an exemplary embodiment, a caller may obtain service area information related to ID information of a callee, and may make a call by using a call function selected based on the obtained service area information. Accordingly, if a terminal device of the callee is connected to a 3G line, since communications are performed in a mode for making a voice call, the communications may not be interrupted and thus may be performed appropriately. Otherwise, if a terminal device of the callee is connected to a home wireless LAN or a public wireless LAN, a call may be made in a mode for making a video call from the caller. In this case, since a wireless LAN is used, even when a video is transmitted and received, communications may not be interrupted and thus may be performed appropriately. Also, if the terminal device is connected to a 3G line, since a voice call is made instead of a video call, traffic of the 3G line may be reduced.

Although, as a terminal device used by a caller, the terminal device 31 is a PC in the above description, the terminal device 31 may also be a TV, a smartphone, or a tablet having a function of an IP phone.

In addition, although a caller selects a call function in correspondence with a network to which a callee's terminal device is connected in the above description, the terminal device 31 of the caller may also select a call function in correspondence with a network to which the callee's terminal device is connected.

An example when the terminal device 31 of the caller selects a call function in correspondence with a network to which the callee's terminal device is connected will now be described. In this case, service area information may indicate a charged wireless LAN line and a network line of a foreign country as well as a home wireless LAN line, a public wireless LAN line, and a 3G line. That is, the service area information may be information indicating the state of using the caller's terminal device.

If the callee's terminal device is connected to a network having a high communication speed and low communication costs, the terminal device 31 may be controlled to perform communications with a sufficient data size.

If the callee's terminal device is connected to a network having high communication costs, the terminal device 31 may be controlled to perform communications with a small data size.

If the callee's terminal device is connected to a network having a low communication speed, the terminal device 31 may be controlled to perform communications with a small data size.

In addition, on the call function selection screen illustrated in FIG. 13, an initial value of a call function may be set based on the service area information and the caller may switch call functions only when there is a change. As the initial value of a call function, for example, a video call may be set for home wireless LAN connection and public wireless LAN connection, and a voice call may be set for 3G line connection.

Also, the terminal device 31 may select a call function only when an initial call is made, and may use the selected call function when subsequent calls are made.

In operations S1 and S2 illustrated in FIG. 12, the service area information may be registered to the registration device 40, for example, when the callee having the ID information turns on a terminal device, or by the callee manually from a terminal device.

There may also be other cases when a terminal device is not turned on, when the service area information is not registered to the registration device 40 even once, and when the callee has only one ID. Accordingly, an initial value of the service area information registered to the registration device 40 may be set as home wireless LAN connection.

Although a caller makes a call to all terminal devices corresponding to IDs of a callee in the above description, the present invention is not limited thereto. For example, if the service area information of the terminal device 50 indicates 3G line connection, the caller may determine that the callee stays outside the first system 10 and thus may make a call only to the terminal device 50.

Otherwise, if the service area information of the terminal device 50 indicates home wireless LAN connection, the caller may determine that the callee stays inside the first system 10 and thus may make a call only to the terminal device 11.

Although the terminal devices 11, 12, and 50 are the callee's terminal devices and the terminal device 31 is the caller's terminal device in the above description, the present invention is not limited thereto. The terminal devices 11, 12, and 50 may be the caller's terminal devices, and the terminal device 31 may be the callee's terminal device. Also, terminal devices (the terminal devices 11, 12, 50, and 31) may include the elements illustrated in FIGS. 8 and 9.

In the above description, a caller selects call functions when a callee's terminal device is connected to a home wireless LAN, a public wireless LAN, or a 3G line.

A call when a PC, a smartphone, or a tablet is connected to an internet via a mobile wireless LAN (fourth communication method) router (hereinafter referred to as a mobile wireless LAN device) using a 3G line will now be described.

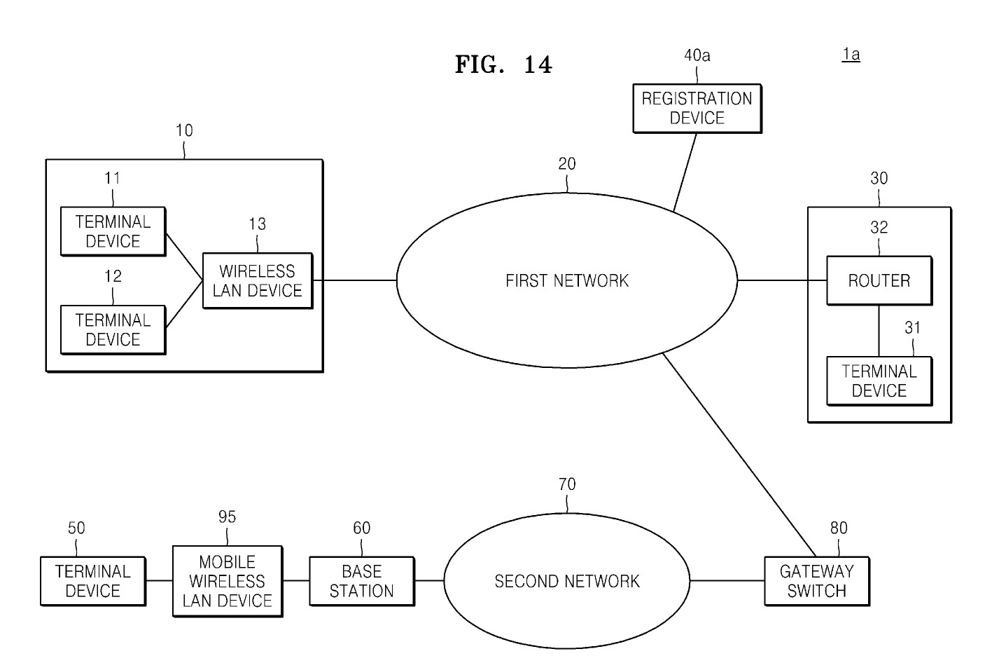

FIG. 14 is a block diagram of a call system 1a for call set-up based on an available network, according to another exemplary embodiment.

Differences from the call system 1 illustrated in FIG. 7 are a registration device 40a and a mobile wireless LAN device 95.

In addition, the terminal devices 11, 12, and 50 may include the elements illustrated in FIG. 8. Also, the terminal device 31 may include the elements illustrated in FIG. 9.

As illustrated in FIG. 14, the terminal device 50 is connected via the mobile wireless LAN device 95 and the base station 60 to the second network 70.

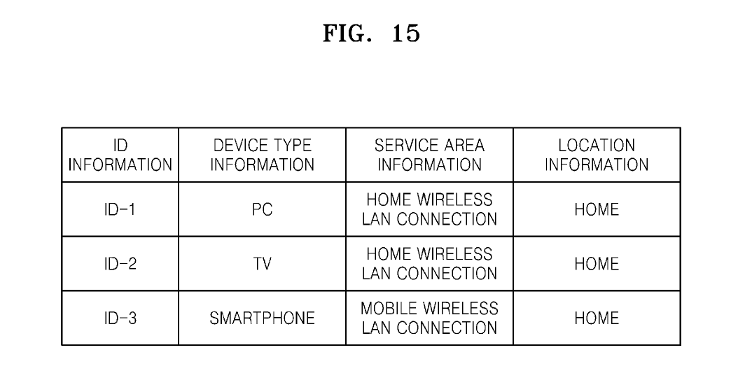

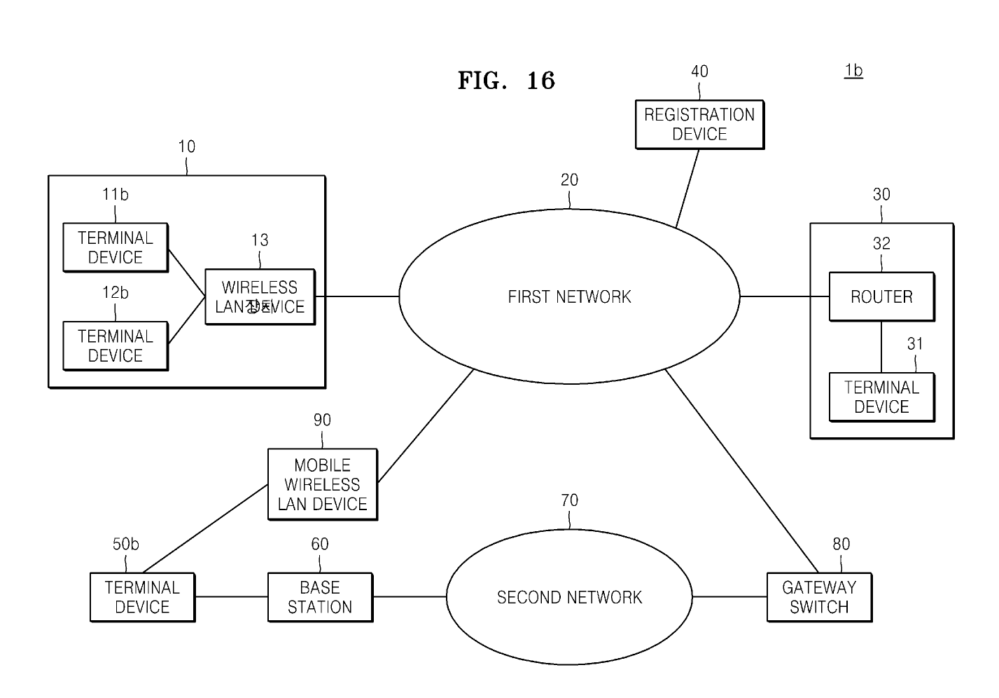

The registration device 40a stores ID information, device type information, service area information, and location information of terminal devices, as shown in FIG. 15.

FIG. 15 is a table showing information registered to the registration device 40a illustrated in FIG. 14, according to an exemplary embodiment.

The location information is information indicating a location where each terminal device is installed or is connected to each network, and includes, for example, the latitude and longitude obtained by a global positioning system (GPS), or an address.

The mobile wireless LAN device 95 has a function of a router for performing communications based on the wireless LAN standards. The terminal device 50 is connected to the mobile wireless LAN device 95. The mobile wireless LAN device 95 connects the terminal device 50 via the base station 60 to the second network 70.

In addition, if the terminal device 50 is connected to the mobile wireless LAN device 95, service area information of the terminal device 50 indicates mobile wireless LAN connection.

The service area information when the mobile wireless LAN device 95 is used will now be described.

The mobile wireless LAN device 95 may be used outside the first system 10 as well as inside the first system 10. The mobile wireless LAN device 95 is used inside the first system 10, the service area information of the terminal device 50 is not sufficient to determine whether a callee is inside or outside the first system 10.

Accordingly, when the service area information of a stationary terminal device used only inside the first system 10, e.g., the terminal device 11 or 12, is registered to the registration device 40, the callee also registers location information about a location where the stationary terminal device is installed. The stationary terminal device is a terminal device used only inside the first system 10, for example, a TV or a desktop computer.

For example, if the terminal device 50 includes a GPS, the service area information and the location information of the terminal device 50 are registered to the registration device 40. If the terminal devices 11 and 12 does not include a GPS, the location information of the terminal devices 11 and 12 may be set as, for example, ‘home’ and thus may be registered to the registration device 40. Alternatively, the location information of the terminal device 50 when it is used home may be registered as the location information of the terminal devices 11 and 12.

If the callee uses the terminal device 50 and the mobile wireless LAN device 95 outside the first system 10, location information obtained by the terminal device 50 is registered to the registration device 40 together with the service area information and thus is updated. The updating process may be performed, for example, in a cycle of a preset time or distance. Alternatively, the updating process may be performed whenever a connection environment of the callee is changed.

If the terminal device 50 does not include a GPS, for example, location information of the base station 60 to which the mobile wireless LAN device 95 is connected may be registered to the registration device 40a as the location information of the terminal device 50.

A caller determines whether the callee stays inside or outside the first system 10 based on the information displayed on the display unit 907 of the terminal device 31. In more detail, if the service area information of the terminal device 50 indicates mobile wireless LAN connection and the location information of the terminal device 50 indicates home, the caller may determine that callee stays inside the first system 10 and may make a call only to, for example, the terminal device 11. Otherwise, if the service area information of the terminal device 50 indicates mobile wireless LAN connection and the location information of the terminal device 50 indicates a place other than home, the caller may determine that the callee stays outside the first system 10 and may make a call only to, for example, the terminal device 50.

As described above, according to the above exemplary embodiment, location information indicating a place where a stationary terminal device is installed may be related to service area information and may be registered the registration device 40a. If a callee connects the terminal device 50 via the mobile wireless LAN device 95 to a network, the location information of the terminal device 50 may be registered to the registration device 40a and updated in a cycle of a preset time or whenever a connection environment is changed. The caller may request the registration device 40a for the location information of every terminal device, and may determine based on a result of the request whether the callee stays inside or outside the first system 10 (home). Based on a result of the determining, the caller may determine whether to switch call functions of each terminal device and to which terminal device a call is made. As a result, a call function may be selected in correspondence to a line to which a terminal device of a callee is connected and thus communications may not be interrupted and may be appropriately performed.

Although a caller views information displayed on the display unit 907 of the terminal device 31 and determines whether to switch call functions of each terminal device and to which terminal device a call is made, in the above description, the terminal device 31 may determine a call function and a terminal device of a callee to which a call is made.

A case when each terminal device of a callee has a call history function will now be described. The call history function is a function of recording in the terminal device information indicating calls from a caller.

For example, an environment in which a callee's terminal devices include the terminal devices 11, 12, and 50 as illustrated in FIG. 7, and a case when the callee brings the terminal device 50 and stays in a room other than the room where the terminal devices 11 and 12 of the first system 10 are installed will now be described.

Initially, as described above in relation to FIGS. 7 through 13, the terminal device 31 displays display information on the display unit 907 based on service area information obtained from the registration device 40.

A caller determined that a callee stays home based on the display information displayed on the display unit 907.

The call unit controller 904 of the terminal device 31 makes a call to all IDs of the callee.

Then, the callee answers the call from the terminal device 31 by using the terminal device 50. In this case, since the terminal devices 11 and 12 do not answer the call from the terminal device 31, a call history is recorded in each of the terminal devices 11 and 12.

If the callee views the call history recorded in each of the terminal devices 11 and 12 and if a plurality of calls are recorded as the call history, the callee may not determine whether the calls are already answered by using the terminal device 50.

Accordingly, a call system 1b according to another exemplary embodiment may synchronize call histories of terminal devices.

FIG. 16 is a block diagram of a call system 1b for call set-up based on an available network, according to another exemplary embodiment.

As illustrated in FIG. 16, an overall configuration of the call system 1b may correspond to that of the call system 1 illustrated in FIG. 7, and functions of terminal devices (terminal devices 11b, 12b, and 50b) are different from those of the terminal devices 11, 12, and 50 illustrated in FIG. 7. In addition, the terminal device 31 may include the elements illustrated in FIG. 9.

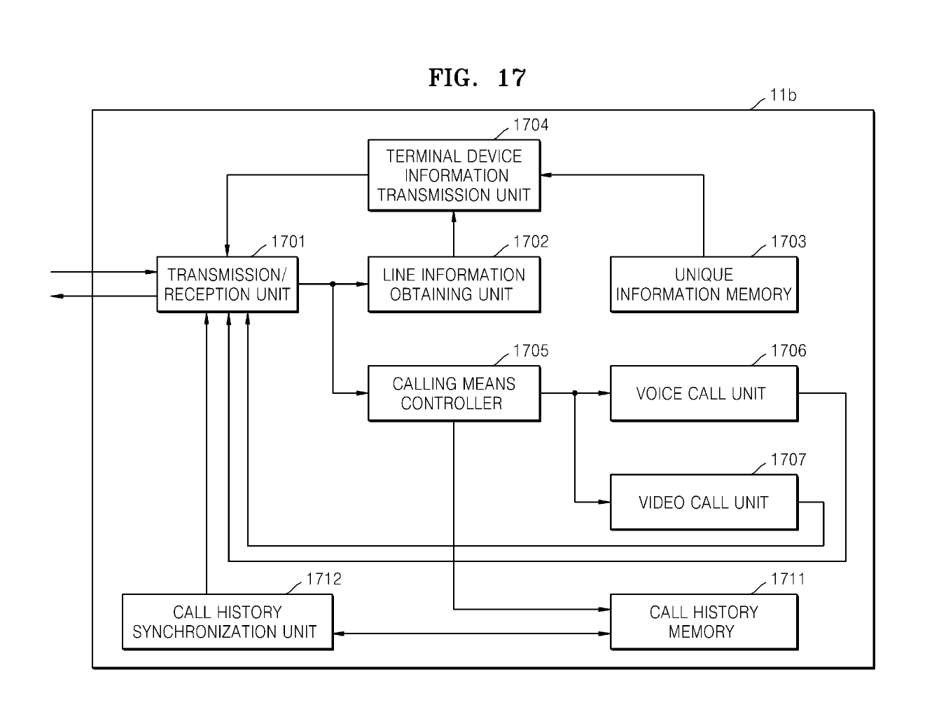

FIG. 17 is a block diagram of the terminal device 11b illustrated in FIG. 16, according to an exemplary embodiment.

As illustrated in FIG. 17, the terminal device 11b includes a transmission/reception unit 1701, a line information obtaining unit 1702, a unique information memory 1703, a terminal device information transmission unit 1704, a call unit controller 1705, a voice call unit 1706, a video call unit 1707, a call history memory 1711, and a call history synchronization unit 1712.

Unlike the terminal device 11 illustrated in FIG. 8, the terminal device 11b illustrated in FIG. 17 may further include the call history memory 1711 and the call history synchronization unit 1712. In addition, configurations of the terminal device 12b and the terminal device 50b may be the same as the configuration of the terminal device 11b.

The call history memory 1711 memorizes a call history indicating calls from a caller. The call history includes, for example, caller information (ID information or a name), a call answering time, and information indicating that a call is answered.

If the terminal device 11b answers a call, the call history synchronization unit 1712 of the terminal device 11b transmits to other terminal devices (the terminal devices 12b and 50b) information indicating that the call is answered.

The call history synchronization unit 1712 of the other terminal devices (the terminal devices 12b and 50b) may synchronize the call history by writing the information received from the terminal device 11b, in the call history memory 1711 of the other terminal devices (the terminal devices 12b and 50b).

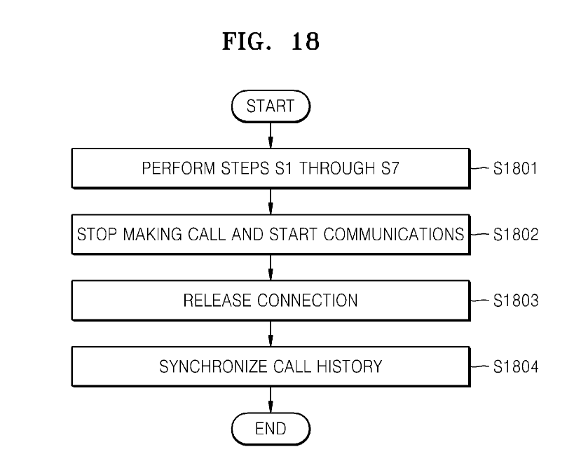

FIG. 18 is a flowchart of a method for call set-up based on an available network, according to another exemplary embodiment.

In operation S1801, as described above in relation to FIG. 12, operations S1 through S7 may be performed.

In operation S1802, the call unit controller 904 of the terminal device 31 determines whether a call from a caller is answered. If the call is answered, the call to terminal devices other than a terminal device that answers the call is stopped. Then, the call unit controller 904 performs communications with the terminal device that answers the call, based on a set call function. In operation S1802, the terminal device 50b may answer the call.

In operation S1803, the call unit controller 904 may release connection with a callee after the communications are completed.

In operation S1804, after the connection with the callee is released, the call history synchronization unit 1712 of the terminal device 50b may synchronize a call history of the terminal devices 11b and 12b installed in the first system 10 with the call history of the terminal device 50b.

In more detail, the call history synchronization unit 1712 of the terminal device 50b may transmit information indicating that the call is answered and memorized in the call history memory 1711, to the terminal devices 11b and 12b via the wireless LAN device 13.

Based on the information received from the terminal device 50b, the call history synchronization unit 1712 of the terminal devices 11b and 12b may update the call history stored in the call history memory 1711.

As such, the call history synchronization unit 1712 of the terminal device 50b that answers the call may synchronize the call history with the other terminal devices 11b and 12b.

In addition, the terminal device 50b that answers the call may update the call history by transmitting to the other terminal devices 11b and 12b information indicating a call time.

As described above, according to the current embodiment, a terminal device that answers a call from a caller may synchronize its call history with those of other terminal devices in the same network. As a result, a callee may view the call history of the terminal device that does not answer the call and may determine that the call is already answered. Accordingly, the callee may determine based on the call history whether to make a call back to the caller.

Although a terminal device of a callee, which answers a call from a caller, synchronizes its call history with those of other terminal devices in the same network in the above description, the terminal device 31 of the caller may control the terminal devices of the callee to update the call history.

In more detail, after the caller completes communications, the terminal device 31 may transmit information indicating a call is answered, to terminal devices which do not answer the call in operation S6, and thus may the terminal devices of the callee to synchronize their call history.

In addition, although service area information indicates home wireless LAN connection, public wireless LAN connection, and 3G line connection in the above description, the present invention is not limited thereto. For example, if a callee brings the terminal device 50 (or 50b) to a foreign country, the service area information registered to the registration device 40 (or 40a) may further include information indicating that the callee stays in a foreign country, and information indicating the country where the callee stays. That is, the service area information may be information indicating the state of using a caller's terminal device. In this case, although the service area information of ID-3 corresponding to the terminal device 50 (or 50b) of the callee indicates 3G line connection, before a call is made, the caller may be aware of that the call will be made to a foreign country. Accordingly, the caller may make a call briefly or at an appropriate time in consideration of a time difference based on the information indicating the country where the callee stays.

Besides, although service area information related to ID information of a callee is registered to the registration device 40 (or 40a) and a caller requests the registration device 40 for the registered service area information in the above description, the present invention is not limited thereto. The call system 1 (or 1a or 1b) may not include the registration device 40 (or 40a).

In this case, the callee may previously transmit to the caller device type information and initial service area information of terminal devices corresponding to the ID information. The information may be transmitted by using, for example, an e-mail, a short message service (SMS), or a multimedia message service (MMS). With respect to only a terminal device to be brought outside the first system 10, e.g., a smartphone or a tablet, if the same communication state is continued more than a predetermined period of time, a terminal device of the callee, for example, the terminal device 50, may transmit to the caller by using an e-mail the service area information indicating that terminal device is connected to a home wireless LAN, a public wireless LAN, or a 3G line. The predetermined period of time may be, for example, an hour.

Also, although service area information indicates home wireless LAN connection, public wireless LAN connection, or 3G line connection in the above description, the present invention is not limited thereto. For example, the service area information may include information indicating a communication standard such as LTE, or femtocell.

Besides, although a caller and a callee use an IP phone service in the above description, P2P or push-type communications may also be used.

The exemplary embodiments can also be implemented as computer-readable codes stored on a computer-readable recording medium and executed by a computer or processor (the computer includes any device having an information processing function). The computer-readable recording medium is any data storage device that can store programs or data which can be thereafter read by a computer system. Examples of the computer-readable recording medium include read-only memory (ROM), random-access memory (RAM), CD-ROMs, magnetic tapes, floppy disks, flash memory, optimal data storage devices, and so on.

While exemplary embodiments have been particularly shown and described, it will be understood by one of ordinary skill in the art that various changes in form and details may be made therein without departing from the spirit and scope of the inventive concept as defined by the following claims and their equivalents.

What is claimed is:

1. A method for call set-up between a receiver and a transmitter via an Internet Protocol (IP) network, the method comprising:
setting a communication environment based on a network available to the receiver; and
setting up a call based on the set communication environment.

2. The method of claim 1, wherein the setting the communication environment comprises:
displaying available communication methods based on the network available to the receiver; and
determining a communication method to be used from among the available display communication methods based on a user input,
wherein the communication method to be used is a voice calling method or a video calling method.

3. The method of claim 1, wherein the setting the communication environment comprises:
displaying available communication devices based on the network available to the receiver; and
determining at least one communication device to which a call request is to be transmitted from among the available communication devices, based on a user input,
wherein the setting up the call comprises transmitting a call request to the determined communication device.

4. The method of claim 3, wherein the displaying the available communication devices comprises, when the receiver is capable of using a home network, displaying a communication device that is capable of using the home network.

5. The method of claim 3, wherein the displaying of the available communication devices comprises, when the receiver is capable of using a public wireless network, displaying a portable communication device that is capable of using the public wireless network.

6. A transmitter comprising:
a communication unit that transmits or receives data via a network;
a communication environment setting unit that sets a communication environment based on a network available to a receiver; and
a transmitting controller that sets up a call via an IP network based on the set communication environment.

7. The transmitter of claim 6, further comprising a display unit that displays available communication method based on the network available to the receiver,
wherein the communication environment setting unit determines a communication method to be used from among the available display communication methods based on a user input, and
wherein the communication method to be used is a voice calling method or a video calling method.

8. The transmitter of claim 6, further comprising a display unit that displays available communication devices based on the network available to the receiver,
wherein the communication environment setting unit determines at least one communication device to which a call request is to be transmitted from among the available communication devices, based on a user input, and
wherein the transmitting controller transmits a call request to the determined communication device.

9. The transmitter of claim 8, wherein, when the receiver is capable of using a home network, the display unit displays a communication device that is capable of using the home network.

10. The transmitter of claim 8, wherein, when the receiver is capable of using a public wireless network, the display unit displays a portable communication device that is capable of using the public wireless network.

11. A computer readable recording medium having recorded thereon a program for executing a method for call set-up between a receiver an and a transmitter via an Internet Protocol (IP) network, the method comprising:
setting a communication environment based on a network available to the receiver; and
setting up a call based on the set communication environment.

12. The method of claim 1, further comprising updating a call history by transmitting information indicating that the receiver answers a call from the transmitter, to other terminal devices of a callee of the receiver.
